(19) United States
(12) Patent Application Publication
(10) Pub. No.: US 2026/0021873 A1
(43) Pub. Date: Jan. 22, 2026

(54) PERSONAL WATERCRAFT

(71) Applicant: KAWASAKI MOTORS, LTD., Hyogo (JP)

(72) Inventors: Tetsuya IWATA, Akashi-shi (JP); Kazunori YAMADA, Akashi-shi (JP)

(73) Assignee: KAWASAKI MOTORS, LTD., Hyogo (JP)

(21) Appl. No.: 18/773,648

(22) Filed: Jul. 16, 2024

(51) Int. Cl. B63B 34/10; A62C 3/10; B63B 25/00

(52) U.S. Cl. CPC B63B 34/10; A62C 3/10; B63B 25/004

(57) ABSTRACT

A personal watercraft includes: a watercraft body; a seat provided in an upper portion of the watercraft body; a storage provided in a front portion of the watercraft body; an equipment case provided at a peripheral position of the storage in the watercraft body to allow equipment equipped in the watercraft body to be stored; and a hatch provided in front of the seat to openably and closably cover the storage and the equipment case.

### FIELD OF INVENTION

The present disclosure relates to a personal watercraft that travels on water.

### BACKGROUND ART

One type of personal watercraft is known from Japanese Patent Application Laid-Open No. 2000-053076. The personal watercraft described in this literature has a storage at the front portion of a watercraft body for storing luggage.

Here, it is conceivable to use the storage not only as a container for luggage, but also, for example, as a container for equipment such as a fire extinguisher. However, if the equipment is stored in the storage, there is a possibility that the equipment will not be able to be taken out smoothly because other luggage inside the storage stands in the way of taking out the equipment.

### SUMMARY OF THE INVENTION

The present disclosure has been made in consideration of the above circumstances, and an object is to provide a personal watercraft that can store equipment in a manner that allows the equipment to be easily taken out.

To solve the above problem, a personal watercraft according to one aspect of the present disclosure includes: a watercraft body; a seat provided in an upper portion of the watercraft body; a storage provided in a front portion of the watercraft body; an equipment case provided at a peripheral position of the storage in the watercraft body to allow equipment equipped in the watercraft body to be stored; and a hatch provided in front of the seat to openably and closably cover the storage and the equipment case.

### BRIEF DESCRIPTION OF THE DRAWINGS

FIG. 1 is a perspective view of a personal watercraft according to one embodiment of the present disclosure, viewed from the front diagonally.

FIG. 2 is a perspective view corresponding to FIG. 1, showing the personal watercraft with a front hatch removed.

FIG. 3 is a plan view showing the personal watercraft with the front hatch removed.

FIG. 4 is a side cross-sectional view showing the personal watercraft with the front hatch removed.

FIG. 5 is a front cross-sectional view taken along the line V-V in FIG. 3, as viewed from the front.

FIG. 6 is a rear cross-sectional view taken along the line VI-VI in FIG. 3, as viewed from the rear.

FIG. 7 is a perspective view showing a fire extinguisher case alone.

FIG. 8 is an enlarged cross-sectional view of an upper portion of the fire extinguisher case.

### DETAILED DESCRIPTION

An embodiment of a personal watercraft according to the present disclosure will be described below with reference to the drawings. Some drawings include indication of front/rear/left/right directions. These directions agree with the directions viewed from a driver boarding the personal watercraft.

### [Overall Configuration of Personal Watercraft]

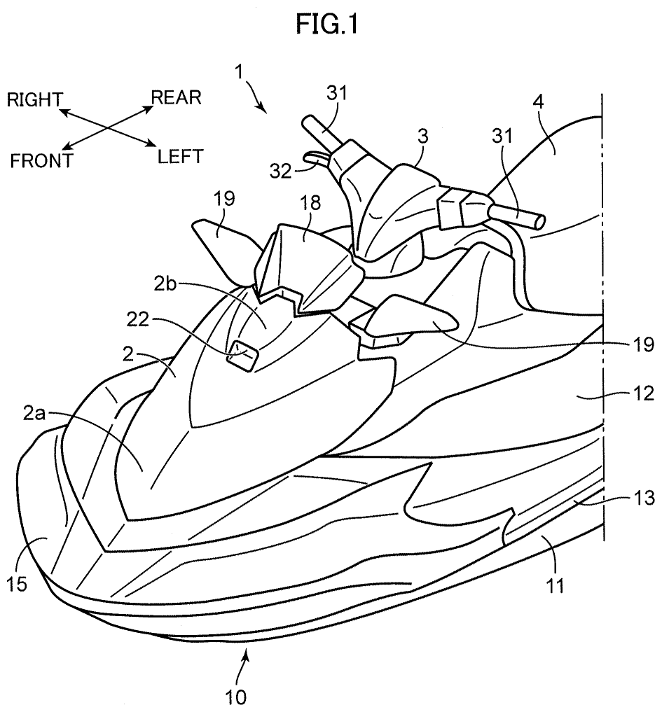

FIG. 1 is a perspective view of a personal watercraft 1 according to one embodiment of the present disclosure. The personal watercraft 1 is a jet propulsion type and straddle-type watercraft that jets water rearward and uses reaction force thereof to travel on water. Hereinafter, the personal watercraft 1 will be abbreviated to PWC 1. The PWC 1 includes a watercraft body 10, a front hatch 2, a handle 3, and a seat 4.

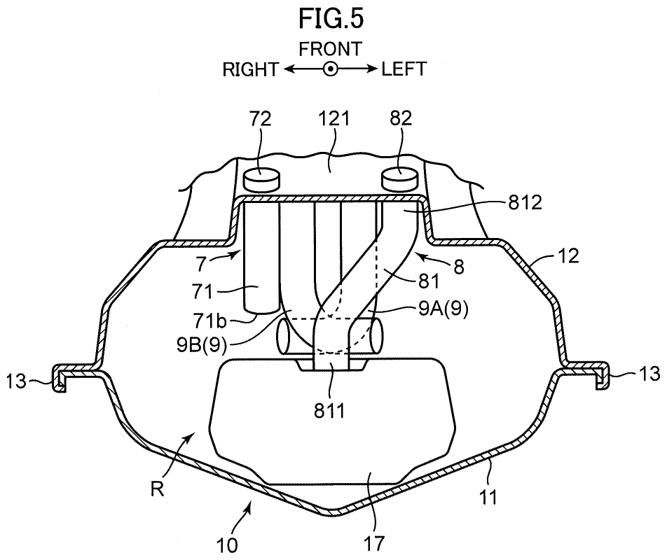

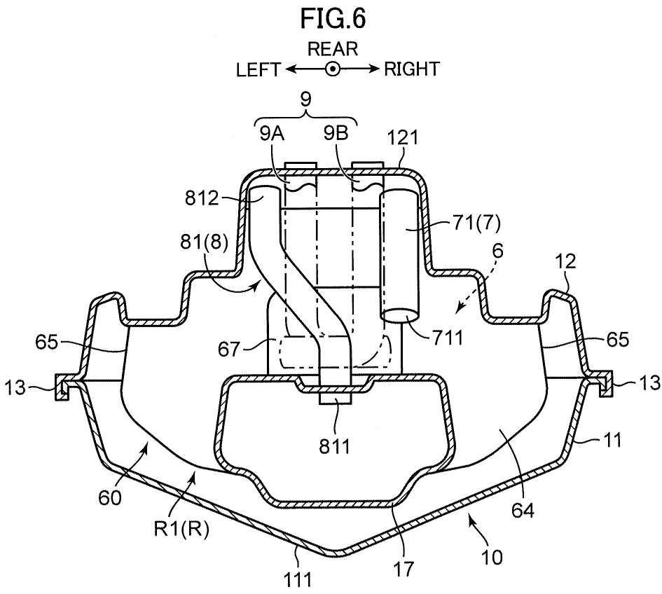

The watercraft body 10 includes a hull 11 and a deck 12. The hull 11 is a bowl-shaped component in cross section that constitutes the bottom of the watercraft body 10, as shown in FIGS. 5 and 6 described later. The deck 12 is a component that covers an upper surface opening of the hull 11. The deck 12 is joined to an opening edge (upper edge) of the hull 11 around the entire periphery. That is, on the periphery of the watercraft body 10, a gunwale 13 is formed, which is a joining line between the hull 11 and the deck 12.

The handle 3 is disposed in the front upper portion of the deck 12. The handle 3 includes a pair of left and right grips 31 for the driver to grasp when steering to change the travel direction of the PWC 1. An accelerator lever 32 is provided in front of the right grip 31. The accelerator lever 32 is a lever for adjusting the travel speed of the PWC 1 by increasing or decreasing the output of an engine 16, which will be described later.

The seat 4 is disposed near the upper center of the deck 12. That is, the seat 4 is installed to cover the upper portion of the deck 12 near the center of the deck 12 located rearward of the handle 3 in the front-and-back direction. The seat 4 is required at least to be a seat where the driver can sit down. That is, the seat 4 may be a multi-person seat that allows not only the driver but also passengers to sit down, or may be a single-person seat that allows only the driver to sit down.

The front hatch 2 is disposed in front of the seat 4 and the handle 3, and is installed to cover the front upper surface of the deck 12. The front hatch 2 is a cover that openably and closably covers a storage 6, which will be described later, and is formed to extend along the front upper surface of the deck 12 in the closed state shown in FIG. 1. Note that the front hatch 2 corresponds to one example of “hatch” in the present disclosure.

Between the front hatch 2 and the handle 3, a meter hood 18 and a pair of left and right side mirrors 19 are disposed. The meter hood 18 is a hood that covers instruments such as a speedometer. The pair of side mirrors 19 are mirrors that reflect the rear area of the watercraft body 10 and are disposed on both left and right sides of the meter hood 18.

A front bumper 15 is installed at the front end of the watercraft body 10. The front bumper 15 is formed to be curved to protrude forward along the gunwale 13 to cover the gunwale 13 at the front end of the watercraft body 10.

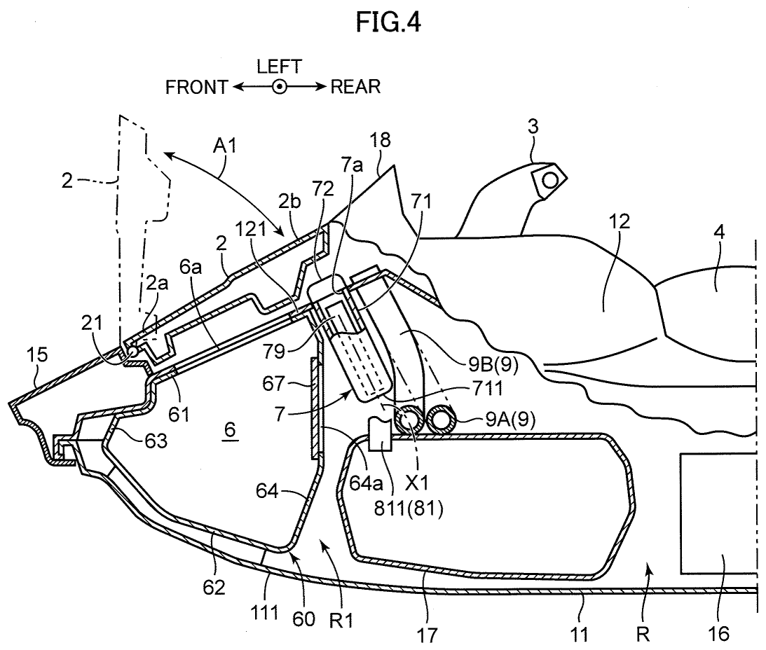

The rear portion of the watercraft body 10 is equipped with a propulsion device that provides propulsion force to the watercraft body 10 by ejection of a jet stream of water. The propulsion device includes an internal combustion type engine 16 (power source) shown in FIG. 4 described later, and an impeller (not shown) that is driven to rotate by the engine 16 to generate a jet stream of water. The engine 16 is disposed in a power compartment R, which is defined between the hull 11 and the deck 12. In a front portion of the power compartment R, a fuel tank 17 is disposed that stores fuel to be supplied to the engine 16.

### [Storage and Surrounding Structure Thereof]

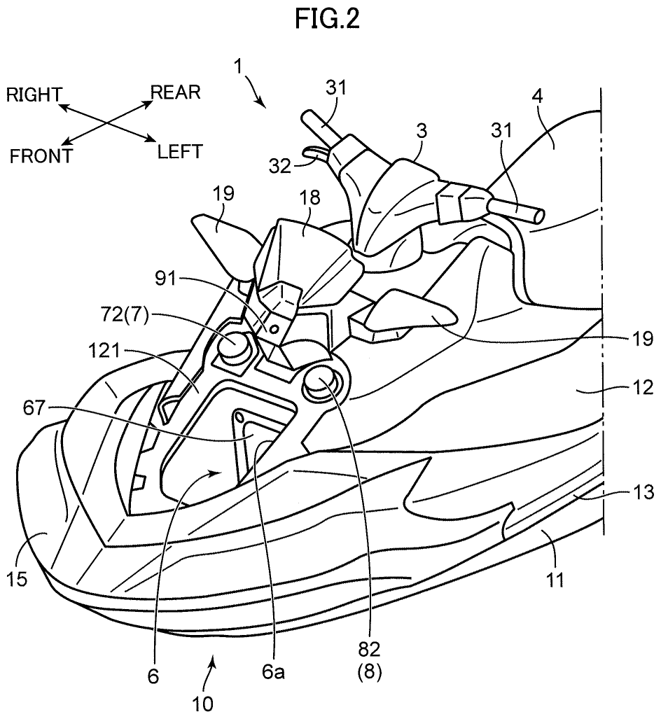

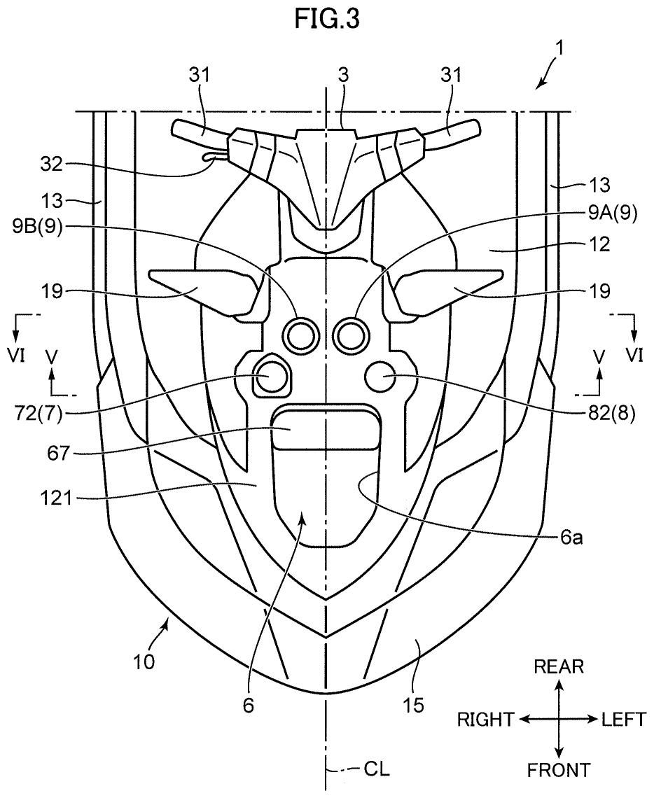

FIG. 2 is a perspective view corresponding to FIG. 1, showing the PWC 1 with the front hatch 2 removed. FIG. 3 is a plan view showing the PWC 1 with the front hatch 2 removed. FIG. 4 is a cross-sectional side view of the PWC 1 with the front hatch 2 installed. As shown in FIGS. 2 to 4, the watercraft body 10 has the storage 6 built in the front portion. The storage 6 is a space defined inside a storage box 60 (FIG. 4), and functions, for example, as a container for storing luggage of occupants including the driver, or the like.

The storage box 60 is disposed in a front accommodation compartment R1, which is a front portion of the power compartment R, mainly as shown in FIG. 4. The front accommodation compartment R1 is a space formed between a front deck wall 121, which is an area in front of the handle 3 in the deck 12, and a front hull wall 111, which is an opposing area to the front deck wall 121 in the hull 11. The front deck wall 121 is inclined to be lower in height toward the front, and the front hull wall 111 is inclined to be higher in height toward the front. With this inclination, the front accommodation compartment R1 is formed such that the distance in the up-and-down direction becomes narrower toward the front.

The storage box 60 is a resin molded body formed by blow molding or the like and is fixed in a state sandwiched between the front deck wall 121 and the front hull wall 111. The storage box 60 is formed to occupy most of the space between the front deck wall 121 and the front hull wall 111, that is, the front accommodation compartment R1. The storage box 60 is formed to have a smaller up-and-down dimension toward the front in correspondence with the shape of the front accommodation compartment R1. The storage box 60 has a bilaterally symmetrical shape with respect to a center line CL (FIG. 3) extending in the front-and-back direction through the center of the width direction of the watercraft body 10, as shown in FIG. 6 described later.

The storage box 60 includes an upper wall 61, a lower wall 62, a front wall 63, a rear wall 64, and a pair of left and right side walls 65 (FIG. 6). The upper wall 61 extends in the front-and-back direction while inclining along the lower surface of the front deck wall 121. The lower wall 62 extends in the front-and-back direction while inclining along the upper surface of the front hull wall 111. The front wall 63 extends in the up-and-down direction to join front ends of the upper wall 61 and the lower wall 62 together. The rear wall 64 extends in the up-and-down direction to join rear ends of the upper wall 61 and the lower wall 62 together. The up-and-down dimension of the rear wall 64 is greater than the up-and-down dimension of the front wall 63. The pair of side walls 65 extends in the up-and-down direction to join side ends of the upper wall 61 and the lower wall 62 together.

The upper wall 61 of the storage box 60 is fixed to the front deck wall 121 in a state of overlapping the front deck wall 121 from below. A storage opening 6a, which opens upward, is formed at the overlapping portion between the upper wall 61 and the front deck wall 121. The storage opening 6a functions as a gateway for taking in and out luggage from the storage 6.

The rear wall 64 of the storage box 60 divides the front accommodation compartment R1 (power compartment R) in the front-and-back direction. A communicating hole 64a having a substantially rectangular shape when viewed from the front is formed in the central portion of the rear wall 64. The communicating hole 64a is closed from the inside by a cover member 67.

FIG. 5 is a front cross-sectional view of a cross section taken along the line V-V of FIG. 3. FIG. 6 is a rear cross-sectional view of a cross section taken along the line VI-VI of FIG. 3. As shown in FIGS. 2 to 6, a fire extinguisher case 7 and a fuel filler 8 are disposed rearward of the storage 6 or the storage box 60. The fire extinguisher case 7 is a case that can store a fire extinguisher 79. The fuel filler 8 is a piping component for receiving fuel supplied to the fuel tank 17. The fire extinguisher 79 is a type of equipment that is required to be equipped in the watercraft body 10. The fire extinguisher case 7 that stores such a fire extinguisher 79 (equipment) corresponds to one example of “equipment case” or “storage case” in the present disclosure.

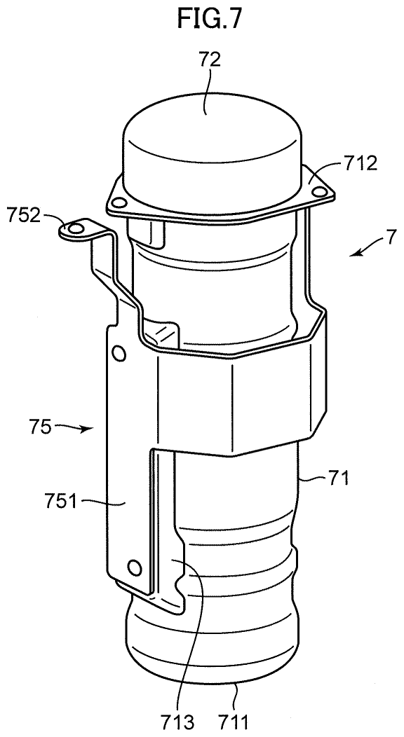

FIG. 7 is a perspective view showing the fire extinguisher case 7 alone. As shown in FIGS. 2 to 7, the fire extinguisher case 7 has a cylindrical shape with a substantially circular cross section and is disposed in a vertical posture with an axis X1 thereof (FIG. 4) extending in the up-and-down direction. In more detail, the fire extinguisher case 7 is disposed in a posture with the axis X1 slightly inclined with respect to the vertical line. In the present embodiment, the axis X1 of the fire extinguisher case 7 extends diagonally forward and upward. In other words, the fire extinguisher case 7 extends in the up-and-down direction with a forward-leaning posture where the upper end is located forward of the lower end.

The axis X1 of the fire extinguisher case 7 is orthogonal to the upper surface of the front deck wall 121. That is, the fire extinguisher case 7 has a shape that extends diagonally downward from the upper surface of the front deck wall 121 to be orthogonal to the upper surface that inclines forward and downward.

The fire extinguisher case 7 includes a case body 71 and a cap 72 attached to the upper end of the case body 71. The case body 71 is a bottomed cylindrical member extending along the axis X1 as described above. The upper end of the case body 71 penetrates the front deck wall 121 to open upward. The lower end of the case body 71 is closed by a bottom wall 711. In other words, the case body 71 is a cylindrical body having a case opening 7a (FIG. 4) that opens upward at the upper end and the bottom wall 711 at the lower end. Although not shown in the figure, water drainage holes are formed in the bottom wall 711 to remove moisture that has entered the case body 71.

The cap 72 is detachably attached to the upper end of the case body 71 protruding above the front deck wall 121 by a suitable method such as screwing. The case opening 7a is opened and closed in response to attachment and detachment of the cap 72. That is, the cap 72 is detachably attached to the upper end of the case body 71 (case opening 7a) to be able to open and close the case opening 7a from above the front deck wall 121. The cap 72 may be coupled to the upper end of the case body 71 or the like via a cord for preventing falling off.

The fire extinguisher 79 stored in the fire extinguisher case 7 has a long shape that extends along the axis X1 of the fire extinguisher case 7. The fire extinguisher 79 has a size, for example, that allows the driver to take out with one hand in an emergency. The volume of the fire extinguisher case 7 that stores such a fire extinguisher 79 is sufficiently smaller than the volume of the storage 6. The size of the opening of the fire extinguisher case 7, that is, the size of the case opening 7a is smaller than the size of the opening of the storage 6, that is, the size of the storage opening 6a. Furthermore, the lower end of the fire extinguisher case 7, that is, the bottom wall 711 of the case body 71 is located above the lower end of the storage 6, that is, the lowest portion of the lower wall 62 of the storage box 60.

The fire extinguisher case 7 restricts the travel of the fire extinguisher 79 in response to the acceleration and deceleration of the watercraft body because the fire extinguisher 79 is accommodated inside. The lower end of the fire extinguisher 79 accommodated in the fire extinguisher case 7 comes into contact with the lower end (bottom surface) of the fire extinguisher case 7. In other words, there is no extra space between the lower end of the fire extinguisher case 7 and the lower end of the fire extinguisher 79. As a result, the height of the lower end of the fire extinguisher case 7 is less likely to be low, making the fire extinguisher case 7 compact. The fire extinguisher 79 accommodated in the fire extinguisher case 7 can be easily taken out from the fire extinguisher case 7 by gripping the upper end.

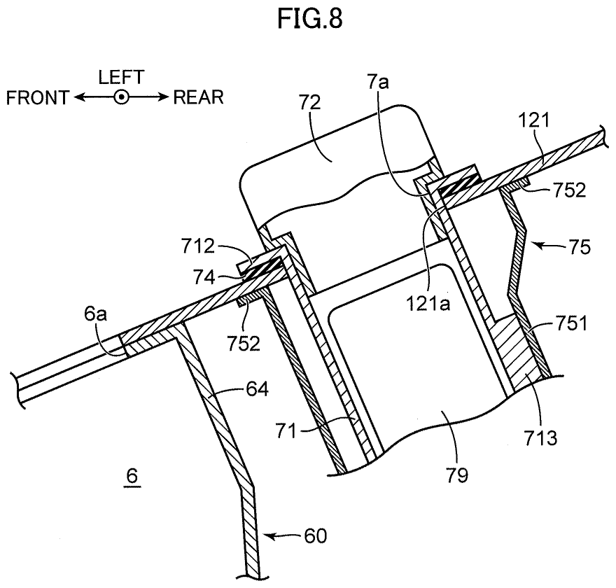

FIG. 8 is an enlarged cross-sectional view of an upper portion of the fire extinguisher case 7. As shown in FIGS. 7 and 8, a flange 712 protruding radially outward is formed at the upper end of the case body 71. A receptacle hole 121a (FIG. 8) capable of receiving the case body 71 inserted from above into the front accommodation compartment R1 (power compartment R) is formed at the rear portion of the front deck wall 121, that is, in a portion located near the rear of the storage 6 within the front deck wall 121. The flange 712 is fastened in a state of being stacked from above the peripheral portion of the receptacle hole 121a. This causes the fire extinguisher case 7 to be fixed in a posture extending in the up-and-down direction inside the front accommodation compartment R1 near the rear of the storage 6. A gasket 74 for sealing is disposed between the flange 712 and the front deck wall 121.

The case body 71 is fixed to the front deck wall 121 via a stay 75 shown in FIG. 7. The stay 75 includes a support part 751 fastened to the case body 71 and a pair of fixing parts 752 that extend upward from the support part 751 and are fixed to the lower surface of the front deck wall 121. A seat portion 713 to which the support part 751 of the stay 75 is to be fastened is formed to extend in the up-and-down direction at the peripheral surface of the case body 71. The case body 71 is fixed to the front deck wall 121 by the seat portion 713 being fastened to the support part 751 of the stay 75 and the flange 712 being fastened to the front deck wall 121.

As shown in FIGS. 2, 3, 5, and other figures, the fire extinguisher case 7 is disposed at a position offset to one side in the width direction from the center line CL (FIG. 3), which is the width center of the watercraft body 10. In the present embodiment, the fire extinguisher case 7 is disposed at a position offset to the right from the center line CL.

In the width direction of the watercraft body 10, the center position of the fire extinguisher case 7 substantially agrees with the position of the corresponding side edge, that is, the right side edge of the storage opening 6a, as shown in FIG. 3. In other words, the fire extinguisher case 7 is disposed such that the center thereof is located on the extension line of the corresponding side edge (right side edge) of the storage opening 6a. Therefore, the outermost edge of the fire extinguisher case 7 located furthest outward in the width direction of the watercraft body 10 protrudes outward of the width range of the storage opening 6a.

As shown in FIGS. 2 to 6, the fuel filler 8 includes a filler pipe 81 extending in the up-and-down direction rearward of the storage 6 or the storage box 60, and a filler cap 82 detachably connected to the upper end of the filler pipe 81.

A lower end 811 of the filler pipe 81 is coupled to the fuel tank 17 and opens into the interior of the fuel tank 17. An upper end 812 of the filler pipe 81 is fixed to the front deck wall 121 near the rear of the storage 6 and penetrates the front deck wall 121 to open upward. An opening at the upper end 812 of the filler pipe 81 functions as an inlet for the fuel to be supplied, that is, a fuel supply port.

The filler cap 82 is detachably attached to the upper end 812 of the filler pipe 81 protruding above the front deck wall 121 by a suitable method such as screwing. In response to the attachment or detachment of the filler cap 82, the opening at the upper end 812 of the filler pipe 81, that is, the fuel supply port is opened and closed. That is, the filler cap 82 is detachably attached to the upper end 812 of the filler pipe 81 (fuel supply port) such that the fuel supply port can be opened and closed from above the front deck wall 121. The filler cap 82 may be coupled to the upper end of the filler pipe 81 or the like via a cord for preventing falling off.

The filler cap 82 is disposed on the opposite side of the fire extinguisher case 7 across the center line CL (FIG. 3), which is the width center of the watercraft body 10, that is, at a position offset to the left of the center line CL. In other words, the fire extinguisher case 7 and the filler cap 82 are disposed side by side in the width direction (right-and-left direction) across the width center of the watercraft body 10 rearward of the storage 6.

In the width direction of the watercraft body 10, the center position of the filler cap 82 substantially agrees with the position of the corresponding side edge, that is, the left side edge of the storage opening 6a, as shown in FIG. 3. In other words, the filler cap 82 is disposed such that the center thereof is located on the extension line of the corresponding side edge (left side edge) of the storage opening 6a. Therefore, the outermost edge of the filler cap 82 located furthest outward in the width direction of the watercraft body 10 protrudes outward of the width range of the storage opening 6a.

The filler pipe 81 extends in the up-and-down direction from the front deck wall 121 to the fuel tank 17 while bending. That is, in the present embodiment, the lower end 811 of the filler pipe 81 is connected to the center of the fuel tank 17 in the width direction. The connection position of the lower end 811 is closer to the width center of the watercraft body 10 (center line CL) than the position of the filler cap 82 that is offset to the left, in other words, closer than the position of the upper end 812 of the filler pipe 81. Therefore, the filler pipe 81 extends in the up-and-down direction while bending in such a manner as to approach the width center of the watercraft body 10 toward the bottom as the filler pipe nears the fuel tank 17.

As shown in FIGS. 3 to 6, further rearward of the fire extinguisher case 7 and the fuel filler 8, a ventilation duct 9 is disposed to ventilate the interior of the watercraft body 10, that is, the power compartment R. The ventilation duct 9 includes a left ventilation duct 9A and a right ventilation duct 9B. The left ventilation duct 9A and the right ventilation duct 9B are each in communication with the power compartment R and the outside air. That is, the left ventilation duct 9A and the right ventilation duct 9B each have an upper end that passes through the front deck wall 121 and opens upward, and a lower end that opens into the power compartment R.

The upper ends of the left ventilation duct 9A and the right ventilation duct 9B are disposed side by side in the width direction (right-and-left direction) across the center line CL, which is the width center of the watercraft body 10. The upper ends of the ventilation ducts 9A and 9B are concealed by a duct cover 91 shown in FIG. 2. FIGS. 3 and 4 show the state where the duct cover 91 is removed. The left ventilation duct 9A and the right ventilation duct 9B are curved in different directions from each other inside the power compartment R such that the lower ends of respective ducts open in opposite directions in the width direction. In the following, when the left ventilation duct 9A and the right ventilation duct 9B are referred to without any distinction, each duct is simply referred to as ventilation duct 9.

As shown in FIG. 4, the ventilation duct 9 is disposed rearward of the fire extinguisher case 7 and alongside the fire extinguisher case 7, extending in the up-and-down direction, when viewed from the side. Similarly, the ventilation duct 9 is disposed rearward of the fuel filler 8 and alongside the fuel filler 8, extending in the up-and-down direction, when viewed from the side. In other words, the fire extinguisher case 7 and the fuel filler 8 are disposed to extend in the up-and-down direction alongside the ventilation duct 9 provided inside the watercraft body 10 (power compartment R).

As shown in FIGS. 1 and 4, the front hatch 2 is attached to the front upper portion of the deck 12 to cover the storage 6 from above. The front hatch 2 is attached to allow tilting in the up-and-down direction around a hinge 21 (FIG. 4) as shown by the arrow A1 in FIG. 4 because the front end 2a is pivotally supported to the deck 12 via the hinge 21. That is, the front hatch 2 is attached to the deck 12 to be displaceable between a closed state shown by the solid line in FIG. 4 and an open state shown by the imaginary line.

A locking mechanism (not shown) that holds the front hatch 2 in the closed state is provided at the rear end 2b of the front hatch 2. An operation unit 22 (FIG. 1) that releases the lock by the locking mechanism is provided in the front hatch 2. To open the front hatch 2, the driver operates the operation unit 22 to release the lock by the locking mechanism, and uses the hand holding the operation unit 22 to pull the front hatch 2 forward and upward. This causes the front hatch 2 to be pushed up as shown by the imaginary line in FIG. 4, exposing the upper surface opening of the storage 6, that is, the storage opening 6a. With the storage opening 6a exposed in this way, it becomes possible to take in and out luggage to and from the storage 6.

Here, the front hatch 2 can cover not only the storage 6 but also the fire extinguisher case 7 and the filler cap 82 from above. That is, the front hatch 2 is formed to extend rearward of the opposing area of the storage opening 6a in the closed state. In this way, the rear end 2b of the front hatch 2 extending to the rear covers the fire extinguisher case 7 and the filler cap 82 from above. Therefore, the fire extinguisher 79 is taken out from the fire extinguisher case 7 and refueling is performed by using the fuel filler 8 with the front hatch 2 open.

That is, when the fire extinguisher 79 is needed, the driver opens the front hatch 2 and then removes the cap 72 of the fire extinguisher case 7. When the cap 72 is removed, the opening at the upper end of the case body 71, that is, the case opening 7a is exposed. This exposure of the case opening 7a makes it possible to take out the fire extinguisher 79 from the case body 71.

Similarly, when refueling is needed, the driver opens the front hatch 2 and then removes the filler cap 82 of the fuel filler 8. When the filler cap 82 is removed, the opening at the upper end 812 of the filler pipe 81, that is, the fuel supply port is exposed. This exposure of the fuel supply port makes it possible to refuel the fuel tank 17 through the filler pipe 81.

In this way, in the present embodiment, the case opening 7a of the fire extinguisher case 7 and the fuel supply port of the fuel filler 8 are each covered from above by the rear end 2b of the front hatch 2. In other words, the front hatch 2 can collectively cover the storage opening 6a of the storage 6, the case opening 7a of the fire extinguisher case 7, and the fuel supply port of the fuel filler 8.

### [Operational Effects]

As described above, in the present embodiment, the front hatch 2 disposed in front of the seat 4 openably and closably covers the storage 6 and the fire extinguisher case 7 located rearward of the storage. Such a configuration provides the advantage of allowing the fire extinguisher 79 as equipment to be stored in a manner that allows it to be easily taken out while reducing the number of components.

That is, in the present embodiment, the common front hatch 2 installed in front of the seat 4 covers the storage 6 and the fire extinguisher case 7, making it possible to take out the fire extinguisher 79 easily when necessary while reducing the number of components. For example, when the fire extinguisher 79 is needed, the driver who is located near the seat 4 can easily operate and open the front hatch 2 disposed in front of the seat 4, thereby allowing the fire extinguisher case 7 to be exposed along with the storage 6. With the fire extinguisher case 7 exposed in this manner, the fire extinguisher 79 can be easily taken out from the fire extinguisher case 7.

The fire extinguisher 79 is stored in the fire extinguisher case 7 provided separately rearward of the storage 6, making it possible to prevent the internal space of the storage 6 from being narrowed by the fire extinguisher 79.

Specifically, in the present embodiment, the storage 6 includes the storage opening 6a that opens upward, and the fire extinguisher case 7 includes the case opening 7a that opens upward at a position separated rearward of the storage opening 6a. The front hatch 2 is installed to cover the storage opening 6a and the case opening 7a from above. Such a configuration allows the fire extinguisher 79 to be easily taken in and out of the fire extinguisher case 7 through the case opening 7a separated (independent) rearward of the storage opening 6a. The storage opening 6a and the case opening 7a can be concealed by the common front hatch 2.

In other words, the fire extinguisher case 7 is disposed outside the storage 6, that is, horizontally away from the storage 6. Therefore, part of the internal space of the storage 6 or the storage opening 6a is not blocked by the fire extinguisher case 7 or the fire extinguisher 79, allowing items to be easily taken in and out of the storage 6.

In the present embodiment, the fire extinguisher case 7 has a bottomed cylindrical shape, and is disposed in a vertical posture with the case opening 7a facing upward. With such a configuration, the fire extinguisher 79 can be easily taken out by pulling the fire extinguisher 79 upward from the case opening 7a.

In more detail, the fire extinguisher case 7 is disposed in a posture with the axis X1 inclined with respect to the vertical line. With such a configuration, it is possible to reduce the occupancy range of the fire extinguisher case 7 in the vertical direction.

In more detail, the fire extinguisher case 7 is inclined such that the upper end is located forward of the lower end. With such a configuration, interference with the storage 6 (storage box 60) located in front of the fire extinguisher case 7 is less likely to occur than when the fire extinguisher case 7 is inclined in the opposite direction. Therefore, it is possible to implement compact layout while avoiding interference between components.

In the present embodiment, the front hatch 2 is attached to the deck 12 to allow tilting in the up-and-down direction with the front end (hinge 21) as a fulcrum. With such a configuration, the opening operation of the front hatch 2 causes the front hatch 2 to move upward away from the upper end of the fire extinguisher case 7 (case opening 7a), making it possible to prevent interference between the front hatch 2 and the fire extinguisher 79 when taking out the fire extinguisher 79 from the fire extinguisher case 7.

In the present embodiment, the fire extinguisher case 7 is disposed at a position offset to one side in the width direction from the width center (center line CL) of the watercraft body 10. With such a configuration, the driver, while located near the seat 4, can easily access the fire extinguisher 79 while avoiding the handle post by stretching forward the hand on the same side as the fire extinguisher case 7 (right hand in the present embodiment).

In the present embodiment, the fire extinguisher case 7 includes the case body 71 having the case opening 7a opposing the front hatch 2 at one end, and the cap 72 detachably attached to the case opening 7a. With such a configuration, the case opening 7a is not exposed even with the front hatch 2 open, making it possible to prevent rainwater or the like from entering the interior of the case body 71.

In the present embodiment, the cap 72 is attached to the upper end of the case body 71 protruding upward of the front deck wall 121. In other words, the cap 72 is attached in a state of protruding upward from the upper surface of the front deck wall 121. With such a configuration, the work to remove the cap 72 from the case body 71 becomes easier, allowing the fire extinguisher 79 to be easily taken out from the case body 71.

In the present embodiment, the ventilation duct 9 is disposed rearward of the fire extinguisher case 7 for ventilating the interior of the watercraft body 10, that is, the power compartment R. With such a configuration, the fire extinguisher case 7 can be appropriately disposed in the space created between the ventilation duct 9 and the storage 6.

In the present embodiment, the filler cap 82 (fuel filler cap) that is detachably attached to the fuel supply port is provided on the opposite side of the fire extinguisher case 7 across the width center of the watercraft body 10. With such a configuration, since the fire extinguisher case 7 and the filler cap 82 are separated in the width direction, the filler cap 82 is less likely to stand in the way when the fire extinguisher 79 is taken in and out.

In other words, the fire extinguisher case 7 and the filler cap 82 are disposed side by side in the width direction of the watercraft body 10 rearward of the storage 6. In this way, when the fire extinguisher case 7 and the filler cap 82 are aligned in the width direction, the occupancy range by both devices in the front-and-back direction can be reduced more than when both devices are aligned in the front-and-back direction. This makes it possible to prepare the storage 6 having a relatively large dimension in the front-and-back direction in front of the fire extinguisher case 7 and the filler cap 82, and to secure sufficient capacity of the storage 6.

### [Variations]

The preferred embodiment of the present disclosure has been described above, but the present disclosure is not limited to this embodiment, and for example, the following variations are possible.

In the above embodiment, the fire extinguisher case 7 is disposed near the rear of the storage 6. However, the fire extinguisher case 7 is required at least to be a separate case provided in a peripheral position of the storage 6, and may be provided at a position other than the rear of the storage 6. For example, the fire extinguisher case 7 may be disposed near either the left or right side of the storage 6 or near the front side of the storage 6. In other words, the fire extinguisher case 7 may be disposed at any position such as in front, rearward, leftward, or rightward of the storage 6. The same is true for the filler cap 82.

In the above embodiment, the fire extinguisher case 7 is disposed in a vertical posture with the axis X1 extending substantially in the up-and-down direction, but the fire extinguisher case 7 may also be disposed in a horizontal posture with the axis extending substantially horizontally. In the above embodiment, the fire extinguisher case 7 is disposed such that the axis X1 is inclined with respect to the vertical line, but the fire extinguisher case 7 may be disposed such that the axis X1 is parallel to the vertical line.

In the above embodiment, one fire extinguisher case 7 is provided near the storage 6, but at least one fire extinguisher case 7 needs to be provided, and two or more fire extinguisher cases 7 may be provided.

In the above embodiment, the fire extinguisher case 7 is disposed at a position offset to the right from the width center (center line CL) of the watercraft body 10. However, the fire extinguisher case 7 may be disposed at the width center of the watercraft body 10, or may be disposed at a position offset to the left from the width center.

In the above embodiment, the fire extinguisher case 7 is formed in a circular cylindrical shape, but the fire extinguisher case 7 may have a shape of an elliptical cylinder or a polygonal cylinder.

In the above embodiment, the ventilation duct 9 and the filler pipe 81 are disposed to extend in parallel to the fire extinguisher case 7. However, some pipe member similar to the ventilation duct 9 and the filler pipe 81 may be disposed in parallel to the fire extinguisher case 7. For example, a steering shaft associated with the handle 3 may extend in parallel to the fire extinguisher case 7. That is, the pipe member extending in parallel to the fire extinguisher case 7 is not limited to the ventilation duct 9 or the filler pipe 81, but may be another pipe member such as a steering shaft.

In the above embodiment, the fire extinguisher case 7 is disposed in front of a pair of ventilation ducts 9 (left ventilation duct 9A and right ventilation duct 9B). However, the fire extinguisher case 7 may be disposed between the pair of ventilation ducts 9, or may be disposed outside the ventilation ducts 9 in the right-and-left direction.

In the above embodiment, the fire extinguisher case 7 (equipment case) that stores the fire extinguisher 79, which is one type of equipment equipped in the watercraft body 10, is disposed around the storage 6. However, instead of such a fire extinguisher case 7, an equipment case that stores equipment other than the fire extinguisher 79 may be disposed. For example, the equipment case may store equipment such as ship inspection certificates, tools, and GPS receivers.

Furthermore, a cylindrical case similar to the fire extinguisher case 7 may be used as a storage case to store an item having a long shape. Examples of such long items include a water bottle, a wallet, a flashlight, a walkie-talkie, a knife, and a writing utensil. The cylindrical storage case can also be used to store items that become long when deformed or folded. Examples of such items include a folding umbrella, a rolled-up raincoat, a rolled-up map, a rolled-up towel, and a swimming ring. Of course, the storage case may store items other than long items, such as communication devices, batteries, and compasses.

The storage case as described above may be applied to the watercraft body 10 that does not include the storage 6 in front of the handle 3. In this case, for example, alongside some pipe member disposed inside the watercraft body 10 in front of the handle 3, the storage case can be disposed to extend along the extension direction of the pipe member.

In the above embodiment, the internal combustion type engine 16 is used as the power source that generates the propulsive force to cause the watercraft body 10 to travel, but the power source is not limited to the engine. For example, an electric motor may be used as the power source, or a hybrid power source that combines an electric motor with an engine may be used.

### CONCLUSION

The above embodiment and the variations include the following disclosure.

A personal watercraft according to one aspect of the present disclosure includes: a watercraft body; a seat provided in an upper portion of the watercraft body; a storage provided in a front portion of the watercraft body; an equipment case provided at a peripheral position of the storage in the watercraft body to allow equipment equipped in the watercraft body to be stored; and a hatch provided in front of the seat to openably and closably cover the storage and the equipment case.

According to the present disclosure, the common hatch installed in front of the seat covers the storage and the equipment case, making it possible to take out the equipment easily when necessary while reducing the number of components.

Preferably, the equipment case is a cylindrical case with an opening at one end and a bottom wall at another end, and is disposed in a vertical posture with the opening facing upward.

According to this aspect, the equipment can be easily taken out by pulling the equipment upward from the opening of the equipment case.

Specifically, the equipment case is preferably disposed in a posture with an axis inclined with respect to a vertical line.

According to this aspect, the occupancy range of the equipment case in the vertical direction can be reduced.

More specifically, the equipment case is preferably inclined such that an upper end is located forward of a lower end.

According to this aspect, interference with a member in front of the equipment case (for example, storage) is less likely to occur than when the equipment case is inclined in the opposite direction. Therefore, it is possible to implement compact layout while avoiding interference between components.

Preferably, the equipment case stores a cylindrical fire extinguisher as the equipment.

According to this aspect, the fire extinguisher can be easily taken out and used in an emergency.

Preferably, the equipment case is disposed rearward of the storage.

According to this aspect, the equipment case is located closer to the seat than the storage, allowing the driver to take out the equipment more easily.

Specifically, preferably, the storage includes a storage opening that opens upward, the equipment case includes a case opening that opens upward at a position rearwardly separated from the storage opening, and the hatch covers the storage opening and the case opening from above.

According to this aspect, the equipment can be easily taken in and out of the equipment case through the case opening separated (independent) rearward of the storage opening. The storage opening and the case opening can be concealed by the common hatch.

Preferably, the equipment case is disposed at a position offset to one side in a width direction from a width center of the watercraft body.

According to this aspect, the driver, while staying near the seat, can easily access the equipment by stretching forward the hand on the same side as the equipment case.

Preferably, the personal watercraft includes a fuel filler cap detachably attached to a fuel supply port at a position on an opposite side of the equipment case across the width center of the watercraft body.

According to this aspect, since the equipment case and the fuel filler cap are separated in the width direction, the fuel filler cap is less likely to stand in the way when the equipment is taken in and out.

Preferably, the equipment case and the fuel filler cap are disposed side by side in the width direction of the watercraft body rearward of the storage.

According to this aspect, since the equipment case and the fuel filler cap are aligned in the width direction, the occupancy range by both devices in the front-and-back direction can be reduced more than when both devices are aligned in the front-and-back direction. This makes it possible to prepare the storage having a relatively large dimension in the front-and-back direction in front of the equipment case and the fuel filler cap, and to secure sufficient capacity of the storage.

Preferably, the equipment case includes a case body having an opening facing the hatch at one end, and a cap detachably attached to the opening of the case body.

According to this aspect, the case body opening is not exposed even with the hatch open, making it possible to prevent rainwater or the like from entering the interior of the case body.

Preferably, the personal watercraft further includes a ventilation duct disposed rearward of the equipment case to ventilate an interior of the watercraft body.

Alternatively, the equipment case has a shape extending in a specific direction alongside a duct provided inside the watercraft body.

According to these aspects, the equipment case can be disposed near the storage while avoiding interference with the ventilation duct (duct).

A personal watercraft according to another aspect of the present disclosure includes: a watercraft body; a seat provided in an upper portion of the watercraft body; a storage provided in a front portion of the watercraft body; a storage case provided at a peripheral position of the storage in the watercraft body, the storage case being separate from the storage; and a hatch provided in front of the seat to openably and closably cover the storage and the storage case, in which the storage case is a cylindrical case with an opening at one end and a bottom wall at another end, and is disposed in a vertical posture with the opening facing upward.

A personal watercraft according to still another aspect of the present disclosure includes: a watercraft body; a seat provided in an upper portion of the watercraft body; a pipe member disposed inside a front portion of the watercraft body; and a storage case provided at a position in front of the seat in the watercraft body and extending in a specific direction alongside the pipe member.

1. A personal watercraft comprising:
a watercraft body;
a seat provided in an upper portion of the watercraft body;
a storage provided in a front portion of the watercraft body;
an equipment case provided at a peripheral position of the storage in the watercraft body to allow equipment equipped in the watercraft body to be stored; and
a hatch provided in front of the seat to openably and closably cover the storage and the equipment case.

2. The personal watercraft according to claim 1, wherein the equipment case is a cylindrical case with an opening at one end and a bottom wall at another end, and is disposed in a vertical posture with the opening facing upward.

3. The personal watercraft according to claim 2, wherein the equipment case is disposed in a posture with an axis inclined with respect to a vertical line.

4. The personal watercraft according to claim 3, wherein the equipment case is inclined such that an upper end is located forward of a lower end.

5. The personal watercraft according to claim 2, wherein the equipment case stores a cylindrical fire extinguisher as the equipment.

6. The personal watercraft according to claim 1, wherein the equipment case is disposed rearward of the storage.

7. The personal watercraft according to claim 6, wherein
the storage includes a storage opening that opens upward,
the equipment case includes a case opening that opens upward at a position rearwardly separated from the storage opening, and
the hatch covers the storage opening and the case opening from above.

8. The personal watercraft according to claim 1, wherein the equipment case is disposed at a position offset to one side in a width direction from a width center of the watercraft body.

9. The personal watercraft according to claim 8, further comprising a fuel filler cap detachably attached to a fuel supply port at a position on an opposite side of the equipment case across the width center of the watercraft body.

10. The personal watercraft according to claim 8, wherein the equipment case and the fuel filler cap are disposed side by side in the width direction of the watercraft body rearward of the storage.

11. The personal watercraft according to claim 1, wherein the equipment case includes a case body having an opening facing the hatch at one end, and a cap detachably attached to the opening of the case body.

12. The personal watercraft according to claim 1, further comprising a ventilation duct disposed rearward of the equipment case to ventilate an interior of the watercraft body.

13. The personal watercraft according to claim 1, wherein the equipment case has a shape extending in a specific direction alongside a duct provided inside the watercraft body.

14. A personal watercraft comprising:
a watercraft body;
a seat provided in an upper portion of the watercraft body;
a storage provided in a front portion of the watercraft body;
a storage case provided at a peripheral position of the storage in the watercraft body, the storage case being separate from the storage; and
a hatch provided in front of the seat to openably and closably cover the storage and the storage case,
wherein the storage case is a cylindrical case with an opening at one end and a bottom wall at another end, and is disposed in a vertical posture with the opening facing upward.

15. A personal watercraft comprising:
a watercraft body;
a seat provided in an upper portion of the watercraft body;
a pipe member disposed inside a front portion of the watercraft body; and
a storage case provided at a position in front of the seat in the watercraft body and extending in a specific direction alongside the pipe member.
